(19) United States
(12) Patent Application Publication
(10) Pub. No.: US 2016/0063862 A1
(43) Pub. Date: Mar. 3, 2016

(54) PARKING SPACE MANAGEMENT SYSTEM AND METHOD

(71) Applicant: Sparkcity.Com Ltd., Tel Aviv (IL)

(72) Inventor: Itamar Rosen, Tel Aviv (IL)

(21) Appl. No.: 14/837,136

(22) Filed: Aug. 27, 2015

Related U.S. Application Data
(60) Provisional application No. 62/042,445, filed on Aug. 27, 2014.

(51) Int. Cl. G08G 1/14

(52) U.S. Cl. CPC G08G 1/14; G06Q 50/26

(57) ABSTRACT

A method of optimizing the use of parking spots in a contiguous parking zone includes dividing a parking zone into a plurality of component parking slots; evaluating the size of a dynamic parking spot required by a specific vehicle having known parking spot size requirements, as a function of the component parking slots, and evaluating the availability in the parking zone of the dynamic parking spot.

### CROSS-REFERENCE TO RELATED APPLICATIONS

This application claims benefit from U.S. Provisional Patent Application No. 62/042,445, filed Aug. 27, 2014, which is hereby incorporated in its entirety by reference.

### FIELD OF THE INVENTION

The present invention relates to vehicle parking space allocation generally and to a system and method for optimizing parking space utilization in particular.

### BACKGROUND OF THE INVENTION

In general, cities have street parking spaces and lot parking spaces. In street parking, a vehicle may be parked parallel, perpendicular, or at an angle with the sidewalk. Perpendicular and angled parking spaces are generally less popular, particularly in high traffic areas or in relative narrow streets as the vehicles protrude further into the middle of the street compared to parallel parking and may interfere with traffic flow. Lot parking spaces are generally oriented to maximize the parking space area within the lot. In some cases, lot parking spaces may include multi-story parking garages.

One of the major challenges confronted by many city or municipal councils is providing sufficient number of parking spaces to meet the needs of its residents as well as those of non-residents who may work in the area, or who may temporarily visit for business or commercial purposes, or simply for leisure purposes. As part of this challenge, factors to be considered may include allowing sufficient temporary stopping spaces required by public transport such as buses and taxi cabs, and by transport vehicles to load and unload goods. In addition, traffic issues must be considered to ensure that the parking spaces as well as the temporary stopping spaces minimally interfere with daytime and nighttime traffic, both of which may vary in intensity sometimes on an hour-by-hour basis. Also to consider is the geographical location of the parking spaces, particularly in city centers where a large population of people is concentrated and parking spaces, whether street parking spaces or lot parking spaces, are generally very limited.

Despite attempts to provide all the parking and stopping spaces to meet the needs of a city or municipality, frequently there is not enough. As a result, a driver may drive around the streets for extended periods of time in search of a parking space, increasing traffic flow and potentially contributing to increased traffic congestion. In an attempt to facilitate the driver's search for a parking space and potentially relieve the associated traffic burden, automated parking space allocation systems have been developed which may pre-allocate a parking space to the driver upon request.

One example of an automated parking space allocation system is disclosed in US Patent Application Publication No. 2013/0143536 to Ratti which relates to a “Real-time parking availability system. The system includes a database including an inventory of parking spaces in a city including their location, size, and level of demand A mobile phone is programmed for access to the database to locate a vacant space, to pay for requested time duration in the space, and to update the database to remove the space from the database of available parking spots for the requested time duration. The parking spaces may accommodate an automobile or a plurality of bicycles”.

Another example of an automated parking space allocation system is disclosed in WO 2012/077086 A1 to Sharon which relates to “Availability statuses of parking spaces are marked, as vacant or occupied, based on parking space reports received from users. The availability statuses and details of the parking spaces, which reside in various geographical locations, are stored in a parking space storage. A vacant parking space is selected from the parking spaces, based on a required parking location and a reservation timing, indicated in a parking reservation request received from a user, and based on the availability statuses of the parking spaces. The vacant parking space is allocated for the user and location details of the vacant parking space are transmitted to the user”.

### SUMMARY OF THE PRESENT INVENTION

There is therefore provided, in accordance with a preferred embodiment of the present invention, a method of optimizing the use of parking spots in a contiguous parking zone. The method includes dividing a parking zone into a plurality of component parking slots, evaluating the size of a dynamic parking spot required by a specific vehicle having known parking spot size requirements, as a function of the component parking slots, evaluating the availability in the parking zone of the dynamic parking spot and informing the driver of the vehicle of the availability.

There is also provided, in accordance with a preferred embodiment of the present invention, a parking space management system. The system includes a database including a plurality of parking slots wherein the parking slots are sized so that one or more component parking slots make up a parking space and an allocator to allocate a dynamic parking space required by a specific vehicle having known parking spot size requirements by allocating more than one adjacent and available parking slots to a vehicle according to a size of the vehicle.

Moreover, in accordance with a preferred embodiment of the present invention, the size of the dynamic parking spot varies between the size of a single component parking slot and multiple component parking slots.

Further, in accordance with a preferred embodiment of the present invention, when evaluating the parking requirements of a plurality of vehicles in a parking zone in at least overlapping time periods, the step of evaluating the size includes the step of performing a best fit analysis of the requirements of all of the vehicles, and evaluating for each the vehicle a dynamic parking spot required thereby so as to provide a dynamic parking spot for all of the vehicles.

Still further, in accordance with a preferred embodiment of the present invention, each vehicle of the plurality of vehicles is assigned a priority status, and if not all the vehicles can be accommodated in the available component parking slots, dynamic parking spots will be evaluated and assigned in order of priority.

Additionally, in accordance with a preferred embodiment of the present invention, the step of evaluating the availability in the parking zone of the dynamic parking spot is for a presently parking vehicle and includes the step of leaving available a maximum number of contiguous component parking slots, thereby to provide a maximum number of dynamic parking spots for additional vehicles to park in the zone while the presently parked vehicle is still parked.

Further, in accordance with a preferred embodiment of the present invention, the method and system includes receiving a notification associated with a vehicle departing from a parking space.

Still further, in accordance with a preferred embodiment of the present invention, the method and system includes determining a number of free slots in the parking zone.

Moreover, in accordance with a preferred embodiment of the present invention, the method and system includes selecting a vehicle from a list of vehicles based on selection rules.

Additionally, in accordance with a preferred embodiment of the present invention, the method and system includes evaluating a size of the selected vehicle.

Further, in accordance with a preferred embodiment of the present invention, the allocating includes use of an allocation algorithm.

Still further, in accordance with a preferred embodiment of the present invention, the allocation algorithm includes any one of a best-fit allocation algorithm and a defragmentation algorithm.

Alternatively, in accordance with a preferred embodiment of the present invention, the allocation algorithm includes a defragmentation algorithm.

Further, in accordance with a preferred embodiment of the present invention, the defragmentation algorithm is based on closest available free parking slots.

Still further, in accordance with a preferred embodiment of the present invention, the defragmentation algorithm is based on vehicle departure times.

Moreover, in accordance with a preferred embodiment of the present invention, the method and system includes storing information associated with a location of the plurality of parking slots.

Additionally, in accordance with a preferred embodiment of the present invention, the method and system includes storing information associated with an occupancy of the plurality of parking slots.

Further, in accordance with a preferred embodiment of the present invention, the method and system includes associating an identification marking on each parking slot of the plurality of slots with its location.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a city section including streets with parking slots, according to an embodiment of the present invention;

FIG. 2A is an exemplary flow chart of the operation of the parking space management system;

FIG. 2B is an exemplary illustration of locations of available and occupied parking slots, useful in understanding FIG. 2A;

FIG. 3A is an exemplary flow chart of the operation of the parking space management system, according to an embodiment of the present invention;

FIG. 3B graphically illustrates the first two steps of the operational flow chart, according to an embodiment of the present invention;

FIG. 4A is a flow chart of an exemplary defragmentation method usable by the parking space management system and based on the closest available parking slots, according to an embodiment of the present invention;

FIG. 4B graphically illustrates the steps of the defragmentation method, according to an embodiment of the present invention;

FIG. 5A is a flow chart of another exemplary defragmentation method usable by the parking space management system and based on vehicle departure time, according to an embodiment of the present invention;

FIG. 5B graphically illustrates the steps of the defragmentation method, according to an embodiment of the present invention; and

FIG. 6 schematically illustrates an exemplary automated parking system including a parking space management system, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Regulation parking spaces on the streets of a city or municipality are generally designated by lines painted on the pavement and arranged perpendicularly to the sidewalk, the lines designating the maximum length and maximum width of the parking space. Typically, these dimensions are fixed for all vehicle parking spaces, generally based on regulatory policy and thus the term “regulation” parking space. Therefore, regardless of whether the vehicle, for example a car, is small or large, the space allocated to the vehicle is the same. As a result, two small cars may take up the same parking spaces as two large cars, potentially resulting in a loss of parking area. This situation may be further aggravated, for example, when a motorcycle takes up a parking space, or when a vehicle which does not fit inside the parking space, such as a truck for example, extends into the adjacent parking space taking up two or more parking spaces.

One may realize from the above discussion that not all spaces designated by the city or municipality as parking spaces are optimally utilized, and therefore there are generally less parking spaces available to drivers at any given moment than actually designated. One may additionally realize that although automated parking space allocation systems known in the art, may be advantageous in assisting a driver to locate a parking space using different allocation techniques, they do not solve the problem faced by many cities and municipalities of optimizing the number of parking spaces made available to its residents and non-residents.

Applicants have realized that the problem of optimizing the number of available parking spaces may be solved by a parking space management system which allows the size of each parking space to be dynamically adjusted according to the size of the vehicle to which the parking space is being allocated. According to an embodiment of the present invention, the “dynamic” parking space may be made up by a variable number of fixed size, “component” parking slots where a plurality of adjacent component parking slots make up a parking space. The component slots may be defined by lines painted on the pavement, with the distance between each painted line maintained to a minimum. In some embodiments, the minimum distance between each line may be that which may allow a driver to easily identify the plurality of parking slots allocated to his or her parking space. In some embodiments, this minimum distance may be that required by to park a motorcycle perpendicularly to the sidewalk.

Applicants have additionally realized that further optimization may be achieved with the parking space management system by allocating component parking slots so that a number of available slots remaining in a parking zone may allow maximum utilization of these available slots for parking other vehicles of various sizes. This allocation by combining the unused component spots or “defragmentation” may be based on determination of the number of available component parking slots remaining on either side of one or more parked vehicles and allocating a combination of these component slots to a parking vehicle such that the remaining available slots are in a direction towards the closest available slots on the other side of the parked vehicle or vehicles. Additionally or alternatively, the defragmentation may be based on determination of the number of component slots which will be made available upon departure of a parked vehicle.

It may be appreciated by the ordinary person skilled in the art that the above realizations by the Applicants, although described with respect to municipal and city parking spaces, may be applied to any type of parking zone or area.

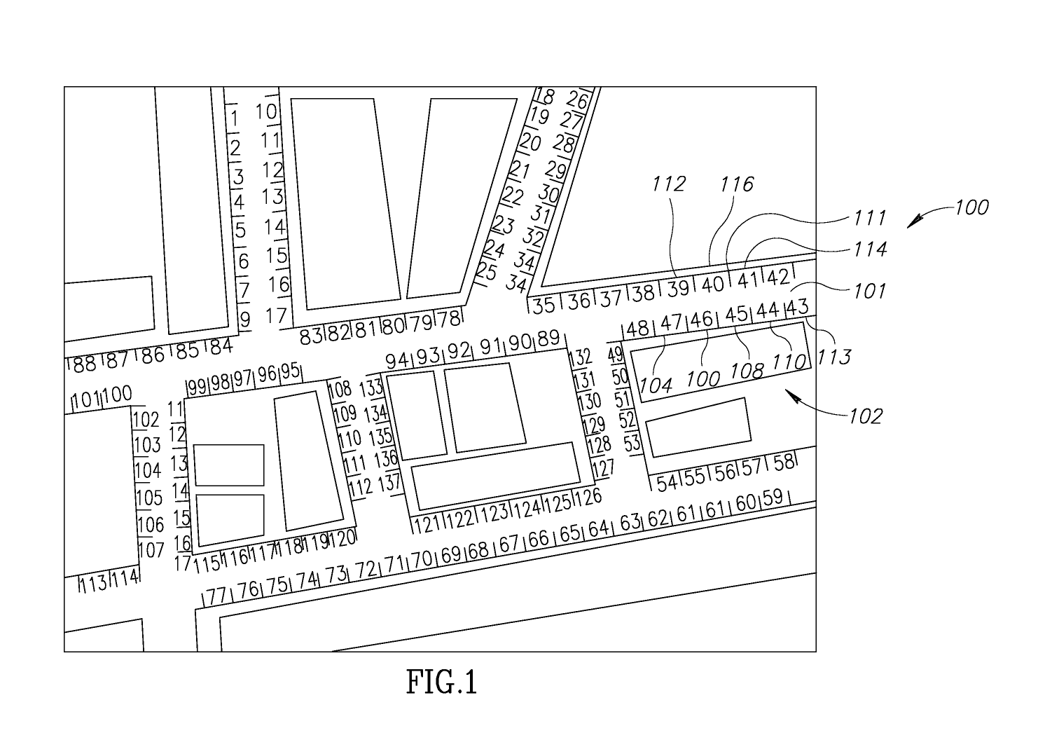

Reference is now made to FIG. 1 which schematically illustrates a city section 100 including streets with parking slots, according to an embodiment of the present invention. City section 100 may include a plurality of streets such as street 101, divided into parking zones such as parking zone 102. Parking zone 102 may be divided into a plurality of equal-size component parking slots such as parking slots 104, 106, 108, 110, 111 and 113. Each parking slot may be defined by markings on the pavement of the street which may, for an example of perpendicular parking, include lines painted perpendicularly to the sidewalk such as lines 112 and 114 delimiting the borders of parking slot 111, and by an identification marking associated with the physical location of the parking slot such as identification number 116 and/or a letter or other type of marking.

The present description discusses parking slots which are defined by perpendicular lines but is not limited to this. The present invention incorporates and may be implemented for other shaped parking slots, such as parallel, perpendicular, or at an angle with the sidewalk, as well.

In accordance with an embodiment of the present invention, a dynamic parking space allocated to four-wheeled vehicles and larger-sized vehicles may include a number of adjacent component parking slots, while a parking space allocated to two-wheeled vehicles may include, although not be limited to, a single component slot suitable to accommodate a two-wheeled vehicle. For example, a two-wheeled vehicle may be allocated a parking space which occupies only parking slot 111; a small-sized car may be allocated a dynamic parking space occupying parking slots 108 and 110; a mid-sized car may be allocated a dynamic parking space occupying parking slots 106, 108, 110; a large-sized car may be allocated a dynamic parking space occupying parking slots 106, 108, 110, and 113; and a van or truck may be allocated a dynamic parking space formed of component parking slots 104, 106, 108, 110, and 113. A length of each parking slot, measured as the distance between the painted lines delimiting the borders of the parking slot, for example painted lines 112 and 116 in slot 111, may be kept as small as possible, yet may be sufficiently large to allow a driver to clearly read the identification markings associated with the allocated parking slots and/or to easily ensure that the vehicle is parked within the allocated parking space defined by the allocated parking slots.

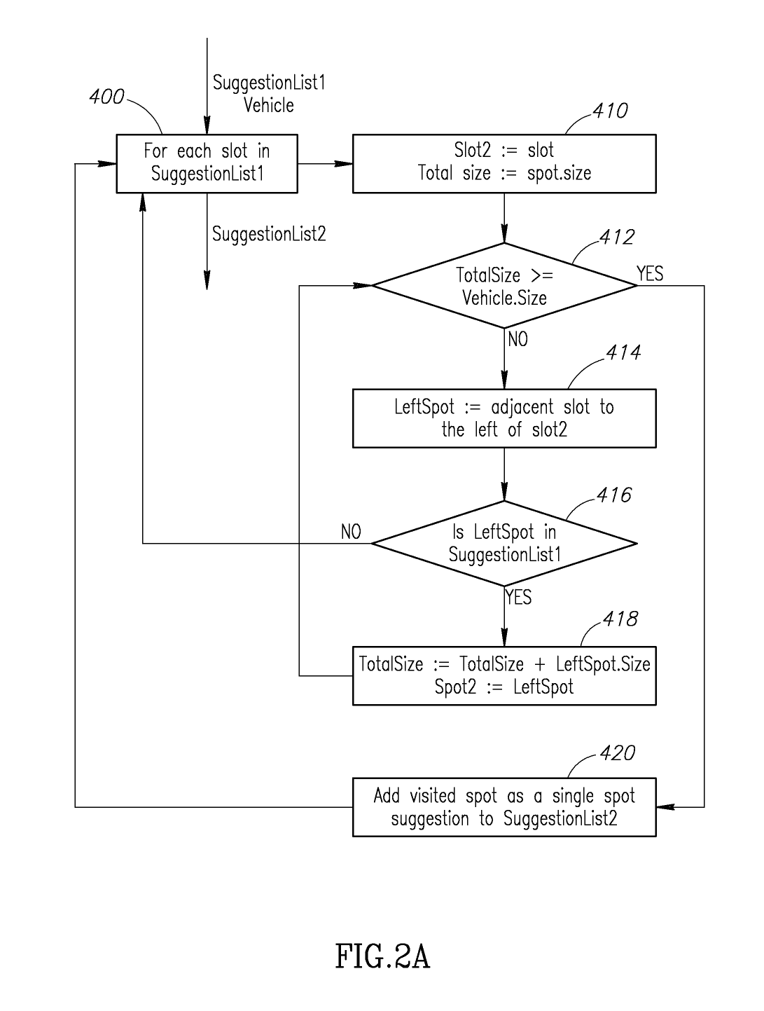

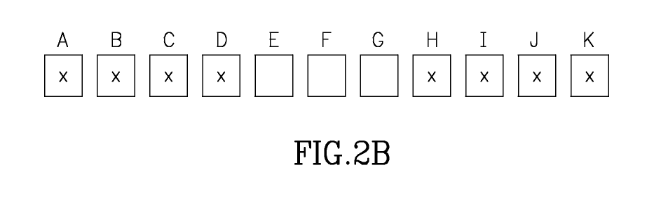

Reference is now made to FIG. 2A which is an exemplary flow chart of the operation of the parking space management system, and to FIG. 2B which is an exemplary illustration of locations of available and occupied parking slots, according to an embodiment of the present invention. Operation of the parking space management system may include of use of automated parking space allocation systems known in the art. An exemplary such system, which may handle parking for a regional authority, is described in the application having attorney docket number P-13070 and entitled “A Parking System and Method”, filed on the same day herewith and assigned to the common assignee of the present invention.

The system may store a size attribute of the vehicle, which may list how many parking spots the specific vehicle requires, and a slot record may list the adjacent component parking slot(s) to the current component parking slot. In one embodiment, only one adjacent component slot, the one to the left, for example, of the current component slot, is stored.

FIG. 2B illustrates the calculation to be made if only the component slot to the left of the current component slot is stored. In the example, 11 small component slots, labeled A-K, are shown and parking for a truck (which in this example requires three neighboring component slots) is desired. Three component slots, E-G are occupied, leaving 2 groups of 4 neighboring component slots, A-D and H-K, available.

FIG. 2A illustrates a BuildSizeAwareList function, given a suggestion list SuggestionList1 of possible component slots and vehicle information, to determine if a group of neighboring slots is available to a current component slot. Suggestion list builder 110 may loop (step 400) on each component slot in the SuggestionList and may, in step 410, initially set a COMPONENT SLOT2 variable to the current component slot and a TOTALSIZE variable to the size of the current component slot. In step 412, a check is made whether the current TOTALSIZE is larger than the vehicle size. If it is not, a loop is entered which will continue until the check is positive. When the TOTALSIZE is smaller than the vehicle size, such as will happen if the component slots are generally smaller than the vehicles, a LEFTCOMPONENT SLOT variable will be set (step 414) to the adjacent component slot of the COMPONENT SLOT2 component slot, which, as described hereinabove, is to the left of the COMPONENT SLOT2 component slot.

As checked in step 416, if the LEFTCOMPONENT SLOT is not in SuggestionList1 (i.e. it was not available when SuggestionList1 was made) or if it is Null, then the loop returns to step 400 for the next component slot. Otherwise (i.e. the LEFTCOMPONENT SLOT is not Null and is in SuggestionList1), then, in step 418, its size of LeftComponent slot is added to TOTALSIZE and LeftComponent slot becomes the new COMPONENT SLOT2. The loop returns to step 412 to see if the current TOTALSIZE is larger than the vehicle size.

The process may continue the loop until TOTALSIZE is larger than the vehicle size (i.e. the sum of the sizes of the adjacent component slots in SuggestionList from the initial component slot is larger than the vehicle size). For example, if the vehicle size is slightly smaller than 2 small component slots, the loop will have repeated once before TOTALSIZE was larger than the vehicle size. If the vehicle size is slightly smaller than 3 small component slots, the loop will have repeated twice before TOTALSIZE was larger than the vehicle size.

Once the loop has finished, in step 420, the visited component slots may be added, as a single dynamic spot, to a new list, Suggestion List2. The single dynamic spot may be defined in any suitable way, such as by the first spot in the list.

The operations of FIG. 2A may find groups of slots that are currently available. However, these slots may be allocated inefficiently and may leave many small component slots unused.

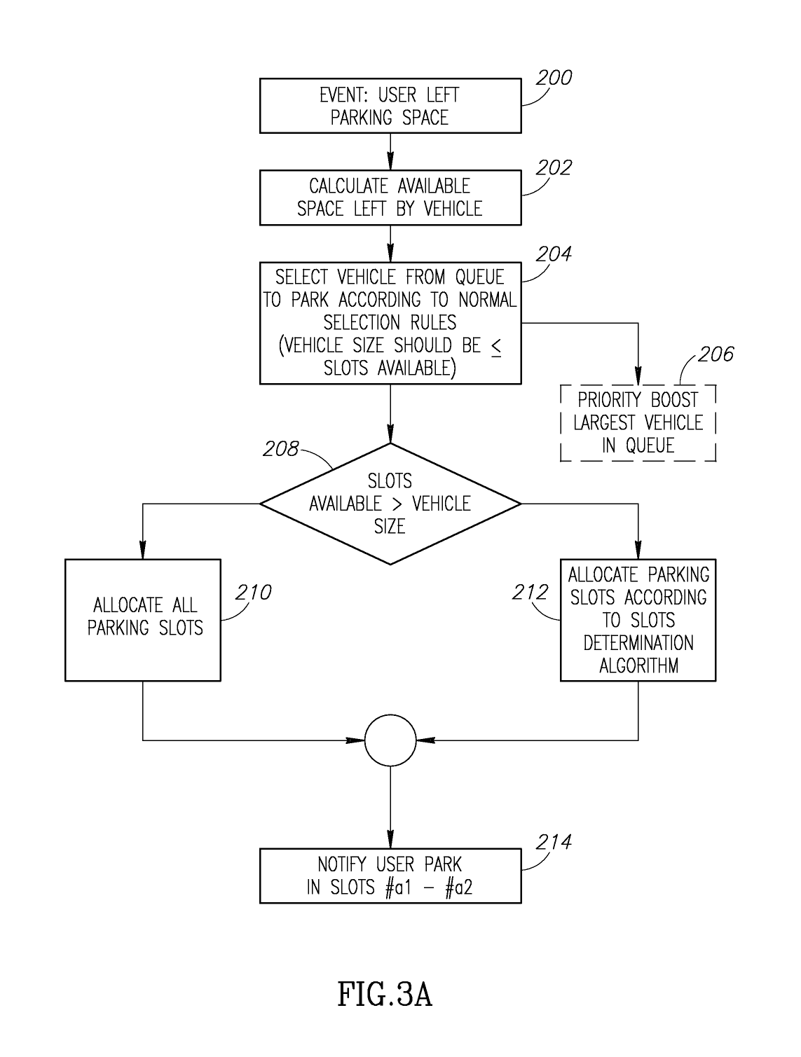

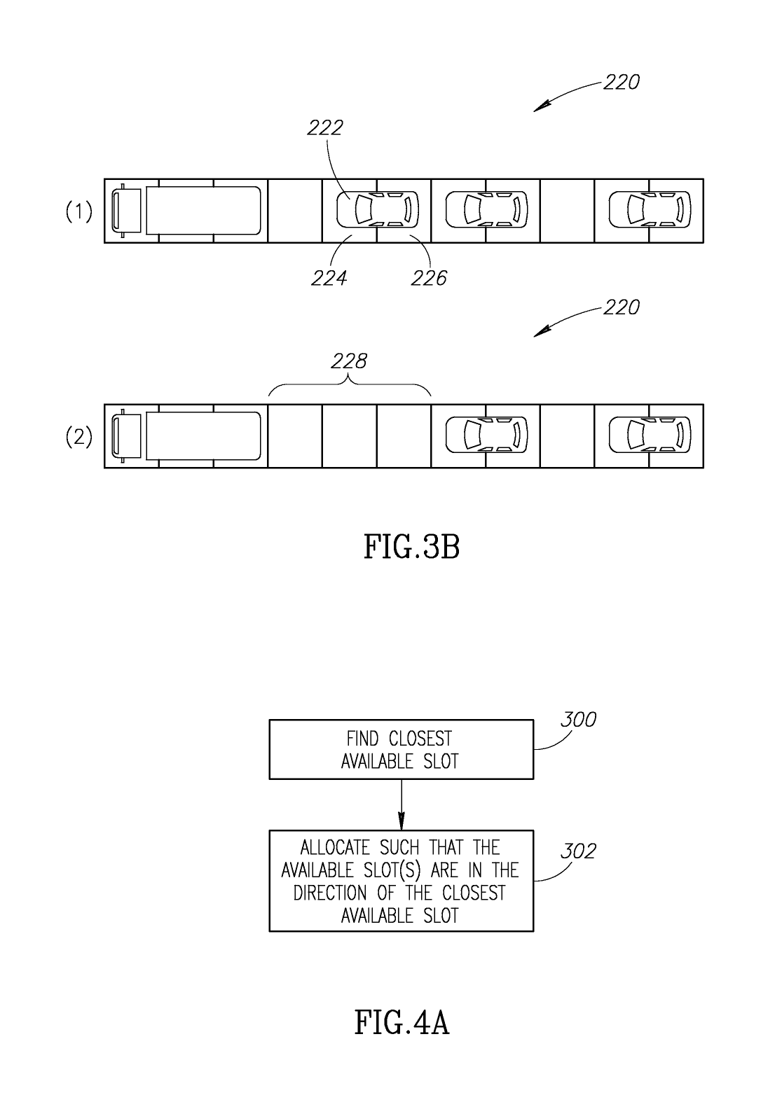

Reference is now made to FIG. 3A which is an exemplary flow chart of a method to increase the efficient use of the component slots, and to FIG. 3B which graphically illustrates the first two steps of the operation, according to an embodiment of the present invention. Operation of the parking space management system may include of use of automated parking space allocation systems known in the art, suitably modified to allocate parking spaces to parking slots and to implement best-fit or other suitable allocation algorithms, and which may include fragmentation and defragmentation algorithms.

At 200, a user in a vehicle parked in a parking space occupying a dynamic parking space composed of several component parking slots may notify the parking space management system of his intended departure, and following the notification, may depart. For example, referring to FIG. 3B(1), the user may be in vehicle 222 occupying slots 224 and 226. When and how actual notification of departure is provided may vary according to the automated parking space allocation system being used.

At 202, the parking space management system looks for contiguous component parking slots. It determines the number of component parking slots vacated by the departed vehicle and calculates the number of available component slots adjacently located to the recently vacated component slots, for example parking slots 224, 226. As shown in FIG. 3B(2), the system determines that there are now three available contiguous component parking slots, indicated as component parking slot group 228.

At 204, the parking space management system selects a vehicle from its queue of vehicles seeking a parking space in a parking zone such as parking zone 220 or in the vicinity of the parking zone. The selection rules for the vehicle may vary according to the automated parking space allocation system being used but should include information regarding the size of the vehicle, such as the number of component parking slots the vehicle requires, in order to determine if the vehicle fit into the available and contiguous component parking slots, for example to available slot group 228. If not, the vehicle is rejected and a new vehicle is selected from the queue.

At 206, as an optional step, the parking space management system may give priority to a specific vehicle requesting a parking space in a parking zone such as parking zone 220 or in the area of the parking zone. For example, if not all vehicles can be accommodated in the available component parking slots, dynamic parking spots will be evaluated and assigned in order of priority and/or vehicles which fit the available dynamic parking spots may be assigned the slots irrespective of the priority they have. The rules for determining priority may vary according to the automated parking space allocation system used.

At 208, the parking space management system determines all combinations of available and contiguous component parking slots that can accommodate the size of the vehicle selected from the queue. The parking space management system may then decide on an allocation method to use, a known allocation method at 210, or a defragmentation method at 212.

At 210, the parking space management system may use the known allocation method which may include the execution of a best fit allocation algorithm or other known allocation method, including fragmentation methods, to allocate the selected vehicle into a parking zone such as, for example parking zone 220. The known allocation method may attempt to fit all vehicles into any parking space within all available and contiguous component parking slots whose combined size is the same or larger than the vehicle size. The known allocation method may also take into consideration conditions associated with the selection rules of the automated parking space allocation system.

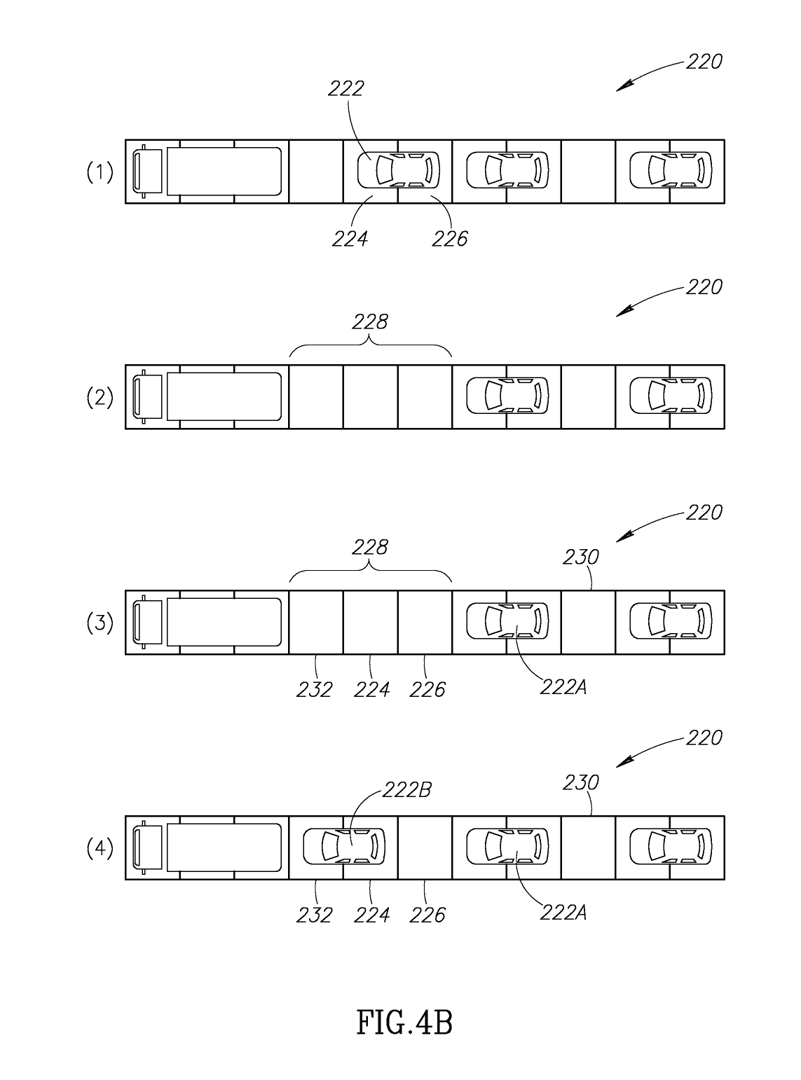

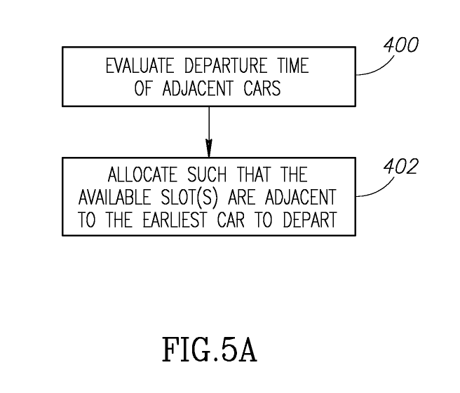

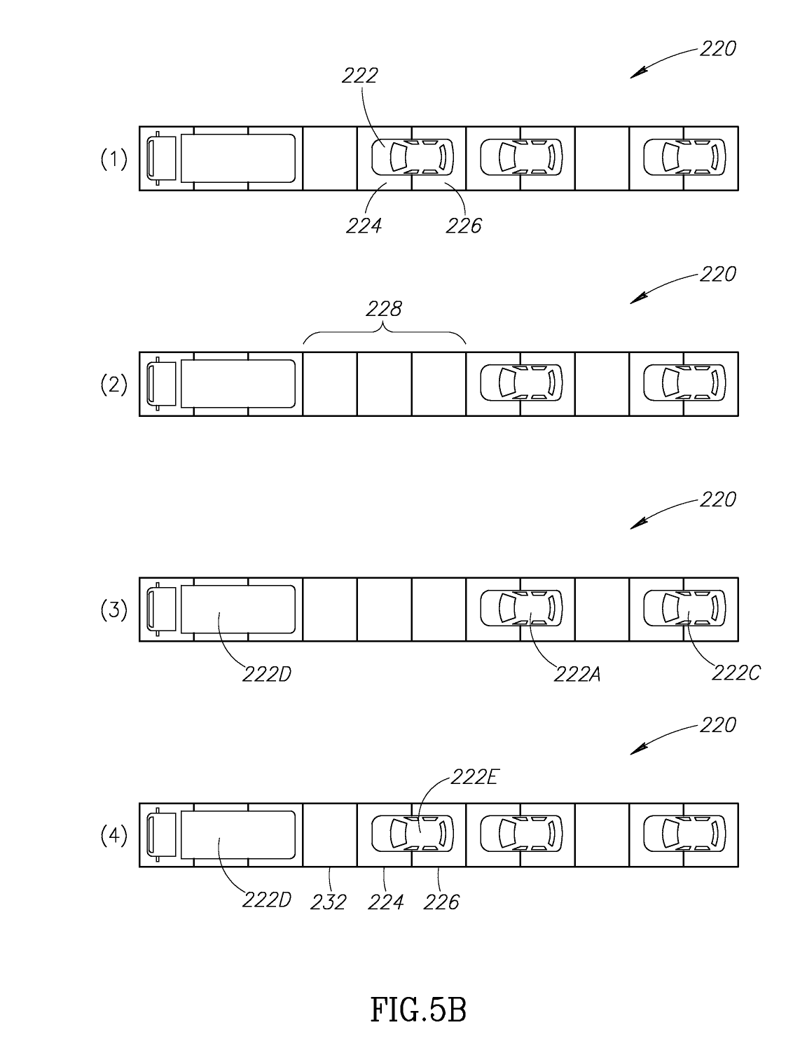

At 212, alternatively to the known allocation method, the parking space management system may use the defragmentation method to allocate the selected vehicle into a parking zone such as, for example parking zone 220. The defragmentation method is described further on below with reference to FIGS. 4A and 4B, and 5A and 5B.

At 214, the user is notified that there is a parking space in a parking zone such as, for example parking zone 220, and the identity of the component slots forming the dynamic spot allocated to the vehicle. The method of notification may vary according to the automated parking space allocation system being used.

It will be appreciated that the allocation process described herein may be implemented in any type of parking space management system.

Reference is now made to FIG. 4A which is a flow chart of an exemplary defragmentation method usable by the parking space management system and based on the closest available component parking slots, and to FIG. 4B which graphically illustrates the steps of the defragmentation method, according to an embodiment of the present invention. FIGS. 4B(1) and 4B(2) correspond with step 200 and FIG. 3B(1), and step 202 and FIG. 3B(2), respectively, and therefore their description is not repeated herein. The system attempts to maximize the available free space, to make it contiguous. To do so, in this embodiment, it looks for available slots in the direction of the closest available component slot.

At 300, the parking space management system determines the available component parking slots on either side of one or more parked vehicles, which component parking slots are closest to one another. For example, referring to FIG. 4B(2) and FIG. 4B(3), available component parking slot 230 on one side of vehicle 222A is closest to available component parking slot group 228 (available component parking slots 224, 226, 232).

At 302, the parking space management system allocates the component parking slots on one side of the parked vehicle or vehicles such that the parking space will be furthest away from the available slots on the other side of the parked vehicle. In this manner, available parking slots remain on both sides of the parked vehicle or vehicle. For example, referring to FIG. 4B(4), parking vehicle 222B is allocated component parking slots 224 and 232 which are furthest from parking slot 230. The result of the defragmentation method is that, after exiting of vehicle 222A, parking slots 226 and 230 may be allocated to new parking spaces.

Reference is now made to FIG. 5A which is a flow chart of another exemplary defragmentation method usable by the parking space management system and based on vehicle departure time, and to FIG. 5B which graphically illustrates the steps of the defragmentation method, according to an embodiment of the present invention. FIGS. 5B(1) and 5B(2) correspond with step 200 and FIG. 3B(1), and step 202 and FIG. 3B(2), respectively, and therefore their description is not repeated herein. In this embodiment, the system looks for available slots near the vehicle most likely to depart soon.

At 400, the parking space management system receives the expected departure times of the parked vehicle, for example, vehicles 222A, 222C, and 222D in FIG. 5B(3).

At 402, the parking space management system allocates a dynamic parking space so that the occupied component parking slots are those furthest away from the earliest departing vehicle, leaving available component parking slots adjacent to the vehicle. For example, referring to FIG. 4B(4), parking vehicle 222E has been allocated parking slots 224 and 226 as vehicle 222D is the earliest departing vehicle, leaving available parking slot 232 adjacent to the parking slots occupied by vehicle 222D.

It will be appreciated that the present invention is operative with component parking slots which are all of the same size or with component parking slots of different sizes. To implement this, parking space management system stores the size of each component parking slot and uses it to determine the total size of the dynamic parking spot.

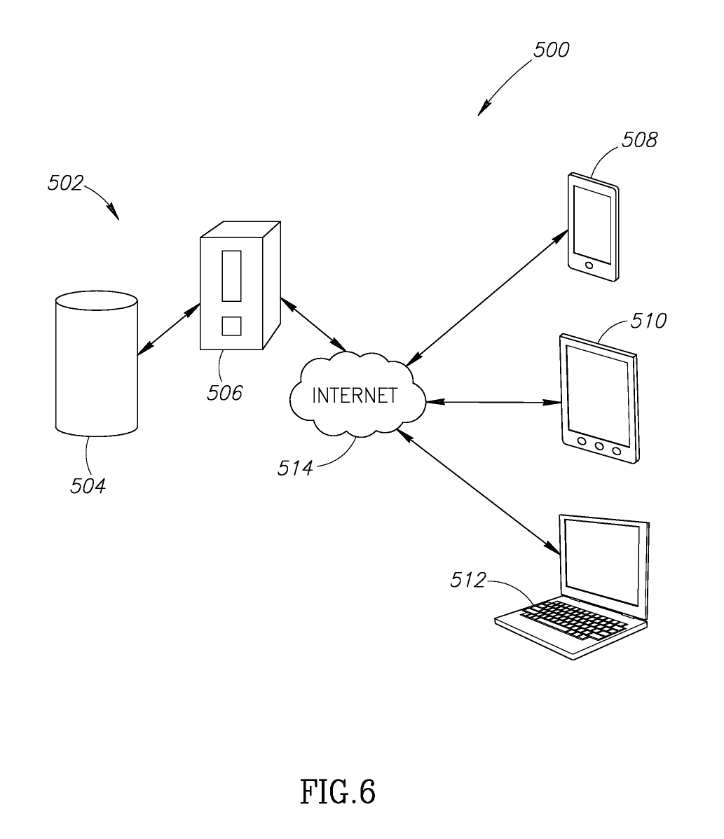

Reference is now made to FIG. 6 which schematically illustrates an exemplary automated parking system 500 including a parking space management system 502, according to an embodiment of the present invention. Parking space management system 502 may include a database 504 and an allocator 506. Automated parking system may additionally include computing devices suitable for communicating and interfacing over the Internet 514 with parking space management system 502, and may include, for example, smart phones 508, tablets 510, and other general purpose computers 512 such as laptop computers and personal computers.

Database 504 may store an inventory of all parking slots within a city or municipality including the geographical location of each parking slot and the identification marking associated with each parking slot. The inventory data may be classified by city sections, parking zones, streets, or any combination thereof, and may include additional information related to allocation of component parking slots to vehicles using the system. Database 504 may additionally store data required by an automated parking space allocation system included in allocator 506.

Allocator 506 may perform all operations associated with allocating parking slots to vehicles, including the steps described with reference to FIGS. 2A and 2B, FIGS. 3A and 3B, and FIGS. 4A and 4B. Allocator 506 may interface with database 504 to obtain and to update component parking slot inventory information, including information regarding available parking slots and occupied parking slots, and to obtain and update data employed by the automated parking allocation system. Allocator 506 may additionally interface with the computing devices over the Internet 514 to receive requests and other information from the computing devices and to transmit information associated with their allocated dynamic parking spaces (allocated parking slots) among other information.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of optimizing the use of parking spots in a contiguous parking zone, the method comprising:
dividing a parking zone into a plurality of component parking slots;
evaluating the size of a dynamic parking spot required by a specific vehicle having known parking spot size requirements, as a function of said component parking slots;
evaluating the availability in said parking zone of said dynamic parking spot; and
informing the driver of the vehicle of said availability.

2. A method according to claim 1, wherein the size of said dynamic parking spot varies between the size of a single component parking slot and multiple component parking slots.

3. A method according to claim 1, wherein when evaluating the parking requirements of a plurality of vehicles in a parking zone in at least overlapping time periods, said step of evaluating the size includes the step of performing a best fit analysis of the requirements of all of the vehicles, and evaluating for each said vehicle a dynamic parking spot required thereby so as to provide a dynamic parking spot for all of said vehicles.

4. A method according to claim 3, wherein each vehicle of said plurality of vehicles is assigned a priority status, and if not all said vehicles can be accommodated in the available component parking slots, dynamic parking spots will be evaluated and assigned in order of priority.

5. A method according to claim 3, wherein said step of evaluating the availability in said parking zone of said dynamic parking spot is for a presently parking vehicle and includes the step of leaving available a maximum number of contiguous component parking slots, thereby to provide a maximum number of dynamic parking spots for additional vehicles to park in said zone while said presently parked vehicle is still parked.

6. A method according to claim 1 further comprising receiving a notification associated with a vehicle departing from a parking space.

7. A method according to claim 1 further comprising determining a number of free slots in said parking zone.

8. A method according to claim 1 further comprising selecting a vehicle from a list of vehicles based on selection rules.

9. A method according to claim 8 comprising evaluating a size of said selected vehicle.

10. A method according to claim 1 wherein said allocating comprises use of an allocation algorithm.

11. A method according to claim 10 wherein said allocation algorithm comprises any one of a best-fit allocation algorithm and a defragmentation algorithm.

12. A method according to claim 10 wherein said allocation algorithm comprises a defragmentation algorithm.

13. A method according to claim 12 wherein said defragmentation algorithm is based on closest available free parking slots.

14. A method according to claim 12 where said defragmentation algorithm is based on vehicle departure times.

15. A method according to claim 1 comprising storing information associated with a location of said plurality of parking slots.

16. A method according to claim 1 comprising storing information associated with an occupancy of said plurality of parking slots.

17. A method according to claim 1 comprising associating an identification marking on each parking slot of said plurality of slots with its location.

18. A parking space management system comprising:
a database comprising a plurality of parking slots wherein said parking slots are sized so that one or more component parking slots make up a parking space;
an allocator to allocate a dynamic parking space required by a specific vehicle having known parking spot size requirements by allocating more than one adjacent and available parking slots to a vehicle according to a size of said vehicle.

19. A system according to claim 18 wherein said allocator receives notifications associated with a vehicle departing from a parking space.

20. A system according to claim 18 wherein said allocator determines a number of free slots in a parking zone.

21. A system according to claim 18 wherein said allocator selects a vehicle from a list of vehicles stored in said database based on selection rules.

22. A system according to claim 21 wherein said allocator evaluates a size of said selected vehicle.

23. A system according to claim 21 wherein said allocator uses an allocation algorithm to perform the allocations.

24. A system according to claim 23 wherein said allocation algorithm comprises any one of a best-fit allocation algorithm and a fragmentation algorithm.

25. A system according to claim 23 wherein said allocation algorithm comprises a defragmentation algorithm.

26. A system according to claim 25 wherein said defragmentation algorithm is based on closest available free parking slots.

27. A system according to claim 26 where said defragmentation algorithm is based on vehicle departure times.

28. A system according to claim 18 wherein said database stores information associated with a location of said plurality of parking slots.

29. A system according to claim 18 wherein said database stores information associated with occupancy of said plurality of parking slots.

30. A system according to claim 18 wherein said allocator associates an identification marking on each parking slot of said plurality of slots with its location.
